(19) United States
(12) Patent Application Publication
(10) Pub. No.: US 2026/0216637 A1
(43) Pub. Date: Jul. 30, 2026

(54) IMPROVEMENTS TO SORBENT FLOW IN CO2 CAPTURE

(71) Applicant: Equinor Low Carbon UK Limited, London (GB)

(72) Inventor: Martin MILLS, Derby, Derbyshire (GB)

(21) Appl. No.: 19/141,859

(22) PCT Filed: Dec. 15, 2023
(86) PCT No.: PCT/EP2023/085999

§ 371 Date: Jun. 20, 2025

(30) Foreign Application Priority Data
Dec. 22, 2022 (GB) 2219512.7

(51) Int. Cl. B01D 53/18; B01D 53/14

(52) U.S. Cl. CPC B01D 53/185; B01D 53/1475; B01D 2257/504; B01D 2258/06

(57) ABSTRACT

A system for the capture of carbon dioxide (CO2) from a CO2 containing gas stream is disclosed. The system includes one or more absorbers to contact the CO2 containing gas stream with a sorbent, a vessel for storing sorbent for the absorber, and intermittently releasing sorbent through the absorber, a lean stream to supply sorbent to the vessel at a constant rate, a release mechanism in fluid communication with vessel and the absorber, configured so that until a sorbent depth in the vessel reaches a threshold, the sorbent is stored, and once the sorbent level in the vessel exceeds the threshold, the sorbent is released through the absorber.

### TECHNICAL FIELD

The present disclosure concerns sorbent flow in a CO2 capture process.

### BACKGROUND

Carbon capture and storage is expected to be a significant way to reduce the effects of global warming from the combustion of fossil fuels.

Capture of carbon dioxide (CO₂) may involve systems for extracting CO₂ from a CO2 containing gas using an absorbent medium. Typically, this involves creating a gas flow over the absorbent medium under conditions where the medium will absorb CO₂ from the gas, and then altering the conditions so that the medium releases the absorbed CO₂ allowing it to be captured and stored. This process may be used to reduce atmospheric CO2 to mitigate the anthropogenic emissions that are associated with global warming, or climate change. Direct Air Capture (DAC) is the capture of CO2 from atmospheric air which, as the atmosphere contains less than 0.05% CO2, involves processing large volumes of air.

Some Direct Air Capture systems use a liquid medium to absorb CO2 in an absorber or liquid-air contactor. There is for example a sorbent containing solution, distributed within the absorber, and it is important to ensure the distribution of sorbent maximises the free surface area to achieve a high transfer of CO2 from the air to the sorbent. There is also a need to prevent the absorber from being clogged up with evaporate or other debris. A way to efficiently manage the flow of sorbent solution within an absorber remains a key problem.

### SUMMARY OF INVENTION

In an aspect, there is provided a system for the capture of carbon dioxide (CO2) from a CO2 containing gas stream, the system comprising one or more absorbers to contact the CO2 containing gas stream with a sorbent, a vessel for storing sorbent for the absorber, and intermittently releasing sorbent through the absorber, a lean stream to supply sorbent to the vessel at a constant rate, and a release mechanism in fluid communication with vessel and the absorber, configured so that until a sorbent depth in the vessel reaches a first threshold, the sorbent is stored, and once the sorbent level in the vessel exceeds the first threshold, the sorbent is released through the absorber. Once the sorbent level in the vessel exceeds the first threshold, the sorbent is released through the absorber until the sorbent level in the vessel is below a second threshold, the second threshold being lower than the first. For example, the second threshold may be lower than 80% of the volume at the first threshold, or lower than 60%. The second threshold may be set such that a predetermined volume of sorbent is released by the release mechanism once the sorbent level in the vessel exceeds first threshold, for example at least 10%, 20% or 30% of the sorbent in the vessel, or at least 50%.

Advantageously the release mechanism can operate using only hydraulic or gravity driven means to control the sorbent release.

The release mechanism can be provided as a passive mechanism that operates without the use of external power and advantageously does not comprise external control signals or sensors.

The release mechanism may comprise a tipping bucket; the tipping bucket attached to a rotatable pivot point, the tipping bucket shaped such that when the sorbent depth in the vessel exceeds the first threshold, the centre of gravity of the bucket is moved so that the tipping bucket rotates around the pivot point and empties the sorbent into the absorber, and then rotates back to the starting position due to gravity.

The release mechanism may alternatively comprise a syphon; the siphon comprising a tube with a first end extending downwards into the vessel, and a second end extending downward outside the vessel, below the first end, such that when the sorbent depth in the vessel exceeds the first threshold the siphon tube fills and begins to siphon sorbent out of the vessel into the absorber until the sorbent depth in the vessel is below the first end.

In an embodiment the release mechanism comprises a partially buoyant component, the component comprising an outlet that remains above the surface of the sorbent in the vessel until the sorbent depth in the vessel reaches the first threshold, and the outlet admits sorbent when the sorbent depth in the vessel exceeds the threshold, causing the partially buoyant component to sink and release sorbent from the vessel via the outlet until the vessel is empty.

The release mechanism is operable to store the sorbent during a first time period and release it through the section of the absorber during a second time period.

In an embodiment, the sum of the second time period and the first time period calculated is set based on the residence time of a packing within the one or more absorbers.

Optionally, there are a plurality of vessels for storing sorbent in each one or more absorbers each with corresponding release mechanisms for releasing the sorbent through the absorber.

Alternatively, there may be a plurality of absorbers in the one or more absorbers, and at least one vessel with corresponding release mechanism is configured to deliver sorbent to more than one of the absorbers.

Preferably, the CO2 containing gas stream is ambient air.

Optionally, the CO2 containing gas stream flows perpendicular to the sorbent flow.

In another aspect, a method of capture of carbon dioxide (CO2) from a CO2 containing gas stream is provided, the method comprising: providing an absorber for contacting sorbent with the CO containing gas stream, storing sorbent for use in the absorber in a vessel, intermittently releasing sorbent into the absorber when the depth of the sorbent in the vessel exceeds a first threshold.

The method may be implemented by intermittently by releasing the sorbent into the absorber using the system of the first aspect.

The skilled person will appreciate that except where mutually exclusive, a feature described in relation to any one of the above aspects may be applied mutatis mutandis to any other aspect. Furthermore except where mutually exclusive any feature described herein may be applied to any aspect and/or combined with any other feature described herein.

### BRIEF DESCRIPTION OF DRAWINGS

Embodiments will now be described by way of example only, with reference to the Figures, in which:

FIG. 1 is a schematic of a prior art carbon capture system;

FIG. 2 is a schematic of a carbon capture system with a vessel for intermittent sorbent delivery.

FIG. 3 is a schematic of a carbon capture system with a siphon for intermittent sorbent delivery.

FIG. 4 is a schematic of a carbon capture system with a tipping bucket for intermittent sorbent delivery.

FIG. 5 is a schematic of a carbon capture system with a tipping bucket for intermittent sorbent delivery.

FIG. 6 is a schematic of a carbon capture system with a floating outlet for intermittent sorbent delivery.

### DETAILED DESCRIPTION

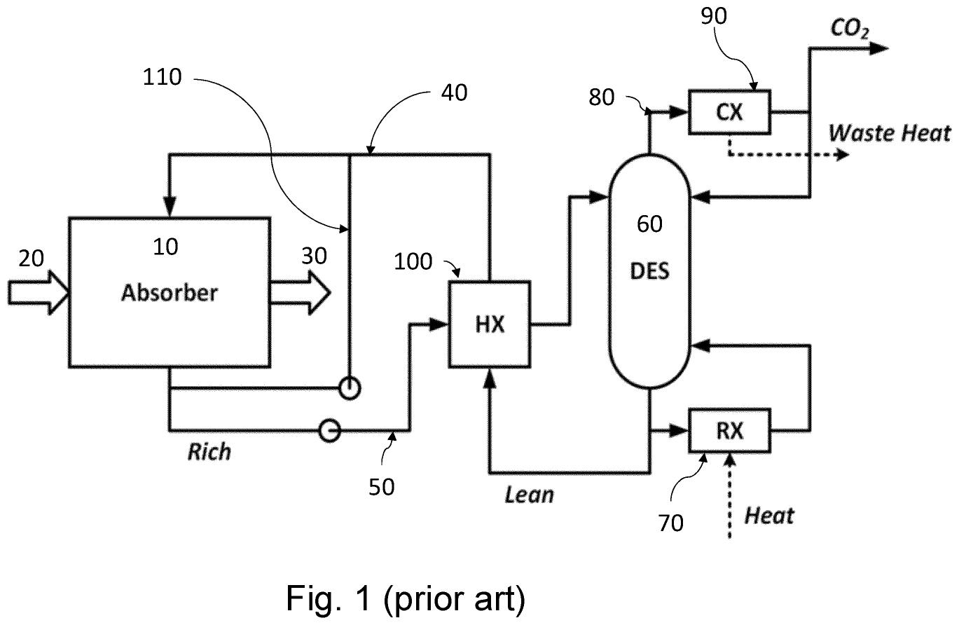

With reference to FIG. 1, which shows a conventional system for carbon capture from a CO2 containing gas. Absorber 10 receives a CO2 containing gas stream from the inlet 20 to outlet 30. A sorbent stream flows through the absorber, a lean stream 40 enters the absorber, contacts the CO2 containing gas and becomes a rich stream 50. Sorbent may be recirculated within the absorber as a recirculation stream 110, which increases the effective residence time of each portion of the lean stream of sorbent in the absorber. The gas stream may flow horizontally as shown, or may flow vertically from bottom to top of the absorber in counterflow to the sorbent stream, or from top to bottom in parallel with the sorbent flow.

The rich stream is typically passed through heat exchanger 100 to recover some heat from the lean stream returning from the desorber 60. Desorber 60 receives the rich stream and heats it up to a temperature where the CO2 will be released form the sorbent, typically using heating means 70 which may also generate steam to form vapour bubbles into which the desorbed CO2 can diffuse, leaving a lean stream of sorbent to return to the absorber to repeat the process.

The vapour and desorbed CO2 exit the desorber at 80, where a condenser 90 is usually used to cool the mixture causing the vapour to condense leaving a purer CO2 product stream.

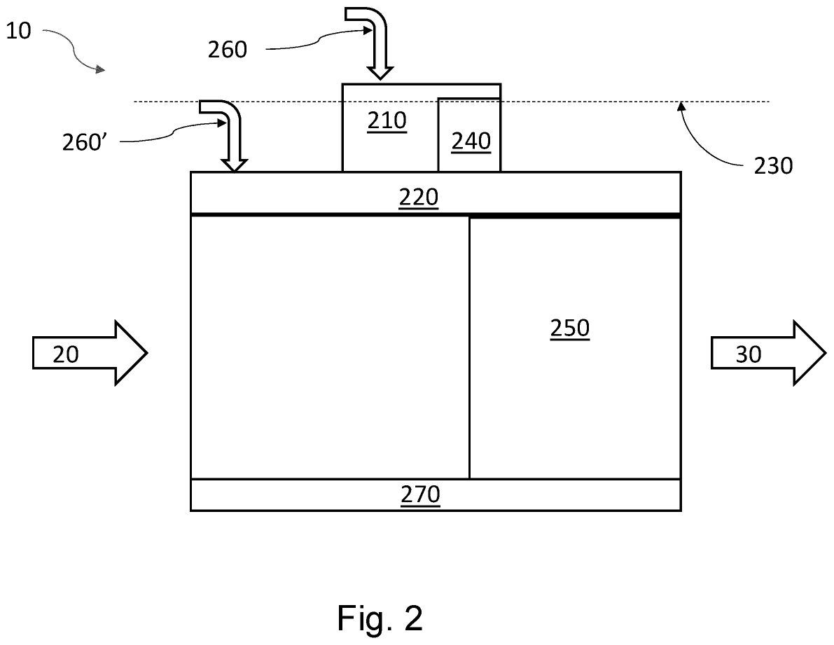

FIG. 2 shows an absorber 10, which may be used in a system like the one in FIG. 1, with a vessel for storing sorbent 210 positioned above the absorber, and an optional distribution mechanism 220 for distributing sorbent across the length and width of the absorber when it is released from the vessel 210. Vessel 210 comprises a release mechanism 240 for releasing sorbent intermittently in pulses either directly into the absorber or via the distribution tray 220. Sorbent supply 260 delivers sorbent into the vessel, which passes through the absorber downwards due to gravity, where it may be collected in a sump 270 after spending a residence time in contact with the airflow between inlet 20 and outlet 30. From the sump, the sorbent may be recirculated through the absorber via sorbent supply 260, while a portion of the sorbent leaves the absorber as rich flow to the desorber 60. Lean sorbent from the desorber may be mixed with the recirculated sorbent in sorbent supply 260, or it may enter the absorber via a different stream.

The absorber may include packing 250 filling or partially filling the absorber 10. The packing may comprise layers or stacked pieces to distribute the sorbent within the absorber and increase the effective surface area of sorbent exposed to the airflow between inlet 20 and outlet 30. The absorber may also include nozzles to distribute the sorbent as a spray or droplets within the absorber. These nozzles may deliver sorbent onto the packing, or create a spray or mist with a high effective surface area directly in the airflow within the absorber.

The release mechanism 240 is configured to release a portion of the sorbent into the absorber, optionally via the distribution tray 220 or directly into nozzles, when the level of sorbent in vessel 210 exceeds a threshold depth 230. The release mechanism 240 may form part of vessel 210 or it may be a separate module fitted to vessel 210, either inside or outside the vessel. The release mechanism 240 is a passive mechanism that operates without the use of external power and does not rely on external control signals or sensors. The release mechanism 240 may be driven by gravity and the mass of sorbent, using buoyancy, siphons and/or tilting mechanisms.

There may optionally be a continuous supply of sorbent 260′ into the absorber separate to the release mechanism. For example, there may be a continuous spray of sorbent, for example as a mist or trickle of sorbent which may be into open space or onto packing, and a second intermittent supply of pulses of sorbent delivered by the release mechanism.

The rate of delivery of pulses may be controlled by varying the rate of flow of sorbent from sorbent supply 260, and by adjustment of the mechanism 240 and the threshold depth 230. In combination with the continuous supply of sorbent 260′, the average rate of sorbent delivery to the absorber can be matched to the rate required to absorb CO2 from the airflow 20, while varying the flow rate in various ways.

One vessel and release mechanism may serve multiple absorbers through distribution pipework. A single absorber may have multiple vessels and release mechanisms, so that sorbent may be intermittently delivered to different portions of the absorber at different times. An absorber array may comprise multiple absorbers, arranged spatially to capture CO2 from a wide geographic area. An array may be fed by multiple sorbent supply systems, and different absorbers or groups of absorbers may be supplied intermittently with pulses of sorbent flow by one or more vessels with associated release mechanisms. A whole array could be fed by gravity supply from a single storage tank positioned above the array, and individual vessels and release mechanisms within the array would operate hydraulically with no requirement for power supplies. Thus, the varied distribution of sorbent to achieve the average flow rate of sorbent necessary to capture CO2 along with the pulsed flow to flush and wet parts of absorbers can be achieved across even a large absorber array using only gravity circulation. A single pump can replenish the sorbent supply tank for the whole array.

The pulses of sorbent serve a number of purposes within the absorber. The pulses may create a sudden increase in pressure at the inlet to nozzles, which will flush the nozzles of any build up of debris, and also create a different flow distribution from the nozzles which can help to entrain any sorbent droplets that may have adhered to surfaces within the absorber. When the sorbent solution contains a solvent, the solvent may evaporate and leave a thicker sorbent solution which will also be entrained by the pulsed flow of sorbent to help move the sorbent towards the sorbent exit of the absorber. In a similar manner, pulses of sorbent will help to flush the distribution tray 220, and the sump 270, to sweep debris into the sorbent recirculation system for removal downstream. Thus, removing need for maintenance personal to go inside an absorber module.

Where the sorbent is distributed onto packing, variations in the flow distribution and the condition of surfaces of the packing may result in uneven distribution of sorbent on the packing surface area. Intermittent large pulse of flow can flood the packing temporarily, allowing more of the effective surface area to be wetted, and entraining rich sorbent that has gathered in pockets within the packing such as in tight corners where surface tension overcomes gravity.

The packing may have a residence time, which is representative of the time it takes for sorbent to drain from the packing after it is applied. The release mechanism may be configured to release sorbent onto the packing at intervals based on the residence time.

The threshold 230 is a first threshold, and there is a lower threshold (not shown on the drawings) below the first threshold that determines when the release of sorbent stops. Therefore a predetermined volume of sorbent is released between the first and second thresholds. This predetermined volume may be sufficient to flush the distribution tray, or wet the packing for example. The predetermined volume may be delivered in a time period so that the rate of delivery of sorbent meets a minimum rate to achieve the desired function. This rate will depend on the configuration of the other plant, for example, if the rate of emptying of the distribution tray is 1 litre per second, and to flush the tray it is desirable to fill the tray to a depth of 20 mm, then for a one square meter distribution tray it would be necessary to deliver 3 litres of sorbent in one second. Similar calculations can be carried out by the skilled person for e.g wetting the packing based on the packing parameters.

The vessel is sized so that it delivers this predetermined volume of sorbent, each time a release is triggered by the depth of sorbent in the vessel. It is not possible to completely fill the vessel, or empty 100% of the contents, but the combination of vessel and release mechanism can be selected to deliver the predetermined volume. For example, after release the vessel may still have 5% of the original sorbent remaining. Or due to the nature of the release mechanism, only a fraction of the sorbent will be released, for example at least 10%, or 20% or 30%. It would be preferable for at least 90% to be released on each activation, to minimise the vessel size, but the important factor is that a predetermined volume is released.

The threshold 230 may be set so that sufficient sorbent is released to fully wet the packing and/or flush the distribution tray and sump, based upon the size of the absorber or absorbers connected. The frequency of the flow pulses set by the inlet flow rate of sorbent supply 260 may be sufficient to provide all the wetting of the packing by providing one pulse at intervals close to the residence time taking account of the faster run off during the initial flow of a pulse. Or the wetting may be achieved using the continuous sorbent supply 260′ and the pulses generated at a much lower frequency to flush the absorber of debris only.

The device provides an intermittent output flow, subject to a constant inlet flow. No moving parts allowing long term operation with little maintenance. Volume and flow rates can be tailored to suit required operational intermittency and outlet flow rate and duration A smaller continually operating feed pump may provide more efficient pumping benefits over a higher duty pump operating intermittently

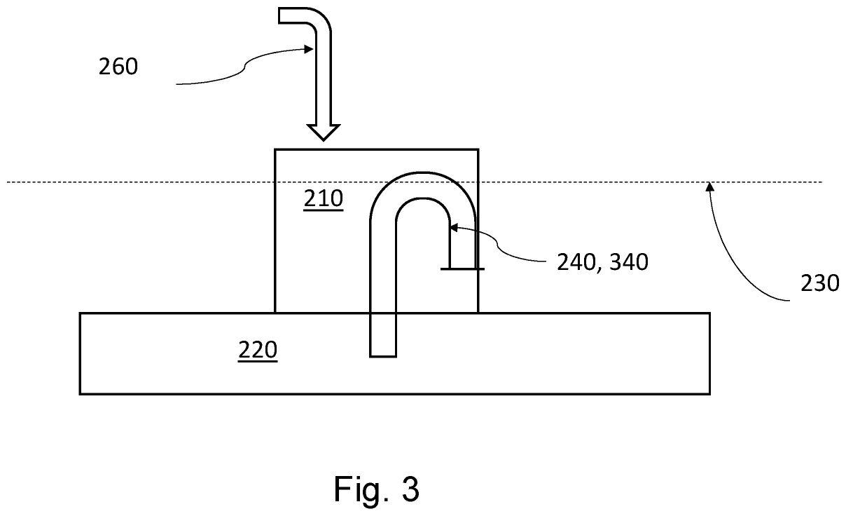

FIG. 3 shows one example of the release mechanism 240 that can be used with the absorber of FIG. 2. A siphon 340 is positioned within the vessel 210 such that when the sorbent depth exceeds the threshold 230, the siphon is filled to above the bend in the siphon conduit, and sorbent is siphoned out of the vessel towards the absorber, or the distribution tray 220 if fitted. Siphons are well known in for example, self flushing urinals, washing machine conditioner dispensers, Pythagorean cups. The length, diameter and height of the siphon can be varied to create a desired flow rate out of vessel 210 once the siphon is initiated. The flow rate out of the vessel will need to be greater than the incoming sorbent flow 260. The siphon need not be a bent tube as shown but can also be realised using conduits of different shapes, or concentric pipes, it can be external to the vessel passing through a wall of the vessel also. A Pythagorean type siphon can take multiple specific forms to fit the required space and volume required.

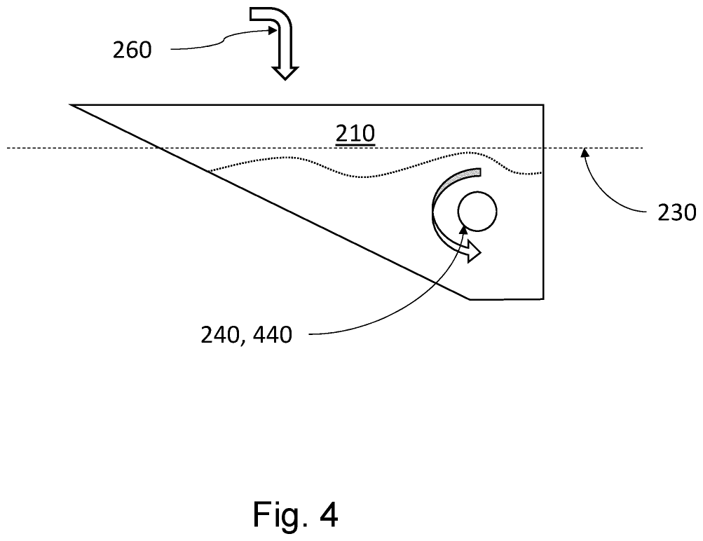

FIG. 4 shows another example of the release mechanism 240 that can be used with the absorber of FIG. 2. Vessel 210 is designed as an asymmetric container supported on a pivot mechanism 440. The container is filled by sorbent supply 260 until the level of sorbent exceeds depth threshold 230, when the centre of gravity of the container causes it to rotate around the pivot 440, emptying the contents of the container into the absorber or the distribution tray. The weight of the container then causes the container to rotate back to the start position. There may be a stop to prevent the container rotating past the start position when it returns. This is similar to tipping buckets used for wave machines in pools for example. The threshold level at which the container begins to tip can be set by the shape of the container, or by adding weight to one side of the container or other.

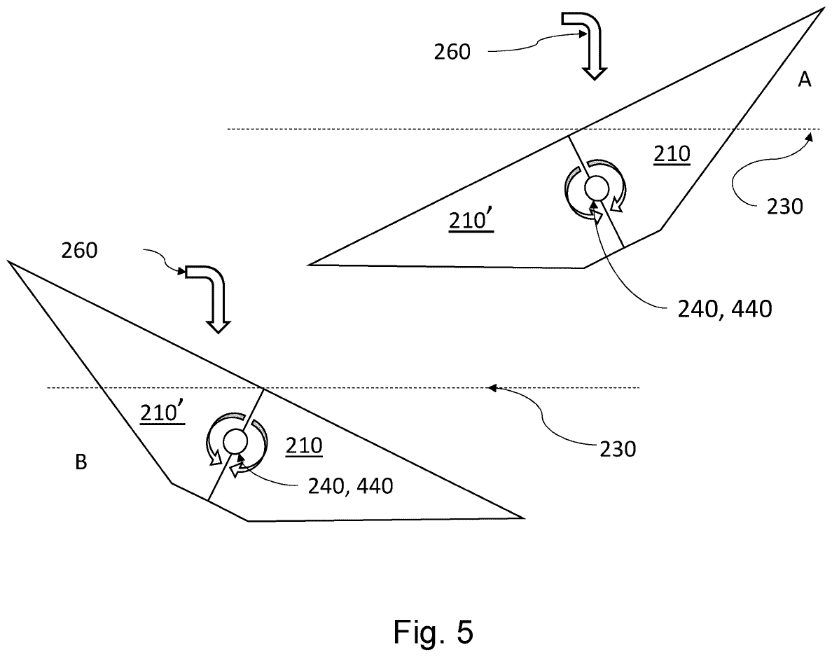

FIG. 5 shows another tipping bucket design to be used for the same purpose as the example in FIG. 4. Here, vessel 210 consists of two vessels, 210 and 210′, with a common pivot mechanism 440. In 5A, vessel 210′ is emptying and vessel 210 is filling from sorbent supply 260. Once the sorbent depth in vessel 210 exceeds the threshold 230, the two vessels tip around the pivot 240, resulting in the position shown in 5B. Now vessel 210′ is filling while 210 is emptying, until the depth of sorbent in vessel 210′ exceeds the threshold 230 and the vessels return to the position in 5A. The vessels may deliver the tipped sorbent into distribution tray 220 (not shown), or they may be arranged to deliver pulses of sorbent to different portions of the absorber on each tip, for example to different portions of packing within the absorber. One of the reasons for this may be to maintain a constant air flow through the packing. The air resistance of the packing will be increased during the flushing period, due to small channels through the packing becoming temporarily filled with sorbent. By flushing separate portions of the packing at different times, at least one portion of the packing will remain clear for airflow.

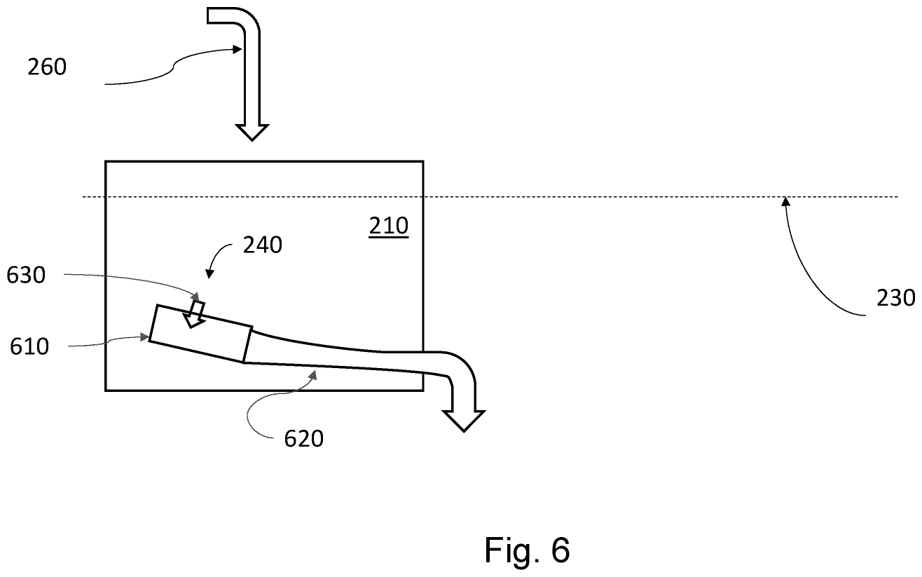

In FIG. 6, which shows an alternative sorbent vessel 210 for use with an absorber as described with reference to FIG. 2. Release mechanism 240 is provided by a buoyant outlet connection. The buoyant outlet comprises a partially buoyant component 610, flexibly connected via a conduit 620 within the sorbent vessel. The component is partially buoyant in that it floats on the sorbent when empty but sinks when partially filled with sorbent. The component 610 includes an outlet 630 connected to the conduit. At the start, when the depth of sorbent is below the threshold 230, the component floats on the sorbent and the outlet is positioned above the surface of the sorbent so that no sorbent enters the conduit. The conduit is able to bend or pivot, for example by the conduit being made from a resilient material, such as a flexible hose. The conduit bends upwards as the sorbent level rises, until the threshold depth is reached, which may be defined by the length of the conduit, or the maximum angle to which the conduit can flex, or an additional stop mechanism such as a connector between the component and the floor of the vessel. Once the threshold depth is exceeded, sorbent will spill into the component, filling the component and/or the flexible conduit with sorbent and reducing the buoyancy so that the component sinks, bringing the outlet below the surface of the sorbent such that the sorbent is fluidically connected through the conduit to the absorber, thus delivering a pulse of sorbent to the absorber at a faster flow rate than the fill rate of the vessel.

The sorbent drains from the component through the outlet until the component is substantially empty. The sorbent vessel continues to fill from the sorbent supply, and the component, once empty of sorbent, is then buoyant again and so begins to float on the sorbent, raising the outlet above the surface of the sorbent and repeating the cycle.

Other examples of hydraulic mechanisms may be used to achieve varying flow through the absorber.

### Sorbent Properties

Sorbents for carbon capture generally have a changing equilibrium between the carbonate/carbamate forms and being in solution with CO2 that depends on temperature, concentration and other factors. Sorbents are carried in a solvent, for example water, which may contain further additives that can act as catalysts, modify the solution physical properties, reduce degradation or other desirable properties.

In general, where the absorber is an air to liquid contactor in a DAC system, the temperature of the sorbent and the temperature of the air within the absorber will be very close, as the sorbent is distributed in a thin film or droplets to achieve a high surface area and contact time, and the air flow is relatively high.

In an operating model of operating a CO2 capture system, other factors than absorbing efficiency may need to be taken into account, such as energy efficiency, sorbent degradation rate, loss of sorbent, maintenance costs etc. For any CO2 capture system the threshold for rate of absorbing may be set taking into account all the other factors, to give the best overall operation of the system.

Sorbents may include alkaline absorbents such as hydroxides or organic sorbents. Alkaline sorbents may include potassium hydroxide or calcium hydroxide. Organic sorbents may include amines, amino acids. Amines may include Ethanolamine (2-aminoethanol, monoethanolamine, ETA, or MEA).

Preferred sorbents include amino acids or alkali salt solutions of amino acids. The amino acids may be derived from the group consisting of alanine, arginine, asparagine, aspartic acid, cysteine, glutamic acid, glutamine, glycine, histidine, isoleucine, leucine, lysine, methionine, ornithine, phenylalanine, proline, sarcosine, selenocysteine, serine, taurine, threonine, tryptophan, tyrosine, or valine. The amino acid may be a compound of an amino acid, such as a methyl amine or diethyl amine.

Preferred alkali component of the amino acid salts is potassium or sodium. Examples of amino acid salts include, sodium glycinate, potassium lysinate.

Amino acids are preferred because they are understood to have lower heat requirements for desorption, have less degradation than amines, and are less hazardous in use than many of the alternatives. They are often also less volatile so that less sorbent evaporates from the solution.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

1. A system for the capture of carbon dioxide (CO2) from a CO2 containing gas stream, the system comprising:
one or more absorbers to contact the CO2 containing gas stream with a sorbent;
a vessel for storing sorbent for the absorber, and intermittently releasing the sorbent through the absorber;
a lean stream to supply sorbent to the vessel at a constant rate; and
a release mechanism driven by gravity in fluid communication with the vessel and the absorber, configured so that until a sorbent depth in the vessel reaches a threshold, the sorbent is stored, and once the sorbent level in the vessel exceeds the threshold, the sorbent is released through the absorber until the sorbent level in the vessel is below a second threshold, the second threshold being lower than the first such that a predetermined volume of sorbent is released by the release mechanism.

2. The system of claim 1, wherein the predetermined volume is greater than 10% of the volume of sorbent stored in the vessel.

3. The system of claim 1, wherein the release mechanism is a passive mechanism that operates without the use of external power and does not comprise external control signals or sensors.

4. The system of claim 1, wherein the release mechanism comprises a tipping bucket; the tipping bucket attached to a rotatable pivot point, the tipping bucket shaped such that when the sorbent depth in the vessel exceeds the threshold, the centre of gravity of the bucket is moved so that the tipping bucket rotates around the pivot point and empties a portion of the sorbent into the absorber, and then rotates back to the starting position due to gravity.

5. The system of claim 1, wherein the release mechanism comprises a syphon; the siphon comprising a tube with a first end extending downwards into the vessel, and a second end extending downward outside the vessel, below the first end,
such that when the sorbent depth in the vessel exceeds the threshold the siphon tube fills and begins to siphon sorbent out of the vessel into the absorber until the sorbent depth in the vessel is below the first end.

6. The system of claim 1, wherein the release mechanism comprises a partially buoyant component, the component comprising an outlet that remains above the surface of the sorbent in the vessel until the sorbent depth in the vessel reaches the threshold, and the outlet admits sorbent when the sorbent depth in the vessel exceeds the threshold, causing the partially buoyant component to sink and release sorbent from the vessel via the outlet until the vessel is empty.

7. The system of claim 1, wherein the release mechanism is operable to store the sorbent during a first time period and release it through the section of the absorber during a second time period.

8. The system of claim 7, wherein the sum of the second time period and the first time period calculated based on the residence time of a packing within the one or more absorbers.

9. The system of claim 1, wherein there are a plurality of vessels for storing sorbent in each one or more absorbers each with corresponding release mechanisms for releasing the sorbent through the absorber.

10. The system of any claim 1, wherein the one or more absorbers comprise a plurality of absorbers, and at least one vessel with corresponding release mechanism is configured to deliver sorbent to more than one of the absorbers.

11. The system of claim 1, wherein the CO2 containing gas stream is ambient air.

12. The system of claim 1, wherein the CO2 containing gas stream flows perpendicular to the sorbent flow.

13. A method of capture of carbon dioxide (CO2) from a CO2 containing gas stream, the method comprising:
providing an absorber for contacting sorbent with the CO containing gas stream,
storing the sorbent for use in the absorber in a vessel,
providing a release mechanism driven by gravity in fluid communication with the vessel and the absorber,
intermittently releasing sorbent into the absorber using the release mechanism when the depth of the sorbent in the vessel exceeds a threshold,
wherein the release mechanism is configured so that until a sorbent depth in the vessel reaches a threshold, the sorbent is stored, and once the sorbent level in the vessel exceeds the threshold, the sorbent is released through the absorber until the sorbent level in the vessel is below a second threshold, the second threshold being lower than the first such that a predetermined volume of sorbent is released by the release mechanism.

14. The method of claim 13, wherein intermittently releasing the sorbent into the absorber is carried out using a system for the capture of CO2 from a CO2 containing gas stream, the system comprising:
one or more absorbers to contact the CO2 containing gas stream with a sorbent, ;
a vessel for storing sorbent for the absorber, and intermittently releasing the sorbent through the absorber;
a lean stream to supply sorbent to the vessel at a constant rate; and
a release mechanism driven by gravity in fluid communication with the vessel and the absorber, configured so that until a sorbent depth in the vessel reaches a threshold, the sorbent is stored, and once the sorbent level in the vessel exceeds the threshold, the sorbent is released through the absorber until the sorbent level in the vessel is below a second threshold, the second threshold being lower than the first such that a predetermined volume of sorbent is released by the release mechanism.
